(19) United States
(12) Patent Application Publication
(10) Pub. No.: US 2021/0042756 A1
(43) Pub. Date: Feb. 11, 2021

(54) Blockchain-based Security Management Method, Related Device and Storage Medium

(71) Applicant: SIMPLECREDIT MICRO-LENDING CO., LTD., Chongqing (CN)

(72) Inventor: Dengchao Zhang, Chongqing (CN)

(21) Appl. No.: 16/978,184

(22) PCT Filed: May 30, 2018
(86) PCT No.: PCT/CN2018/089008

§ 371 Date: Sep. 3, 2020

(51) Int. Cl. G06Q 20/40; G06Q 20/06

(52) U.S. Cl. CPC G06Q 20/4016; G06Q 2220/00; G06Q 20/4015; G06Q 20/0655

(57) ABSTRACT

The present invention provides a blockchain-based security management method, a related device and a storage medium, wherein the method is applied to a security management platform, and comprises: acquiring a state information of a first blockchain account, wherein the state information comprises at least one of a login location and a transaction situation, and the first blockchain account is any one of blockchain accounts registered on the security management platform; judging whether the first blockchain account is abnormal or not according to the state information; and monitoring a fund flow direction of the first blockchain account in the blockchain network if the first blockchain account is abnormal. According to the method, the device and the storage medium provided by embodiments of the present invention, the blockchain account can be monitored and fund security can be guaranteed.

### FIELD OF THE INVENTION

The present invention relates to the technical field of blockchains, and particularly relates to a blockchain-based security management method, a related device and a storage medium.

### BACKGROUND OF THE INVENTION

A blockchain is a chain data structure formed by combining data blocks in a way of sequential connection in chronological order and a tamper-proof and forgery-proof distributed accounting system which is guaranteed in a cryptography mode. With the development of the blockchain technology, blockchain systems represented by Bitcoin have received more and more attention in recent years, especially in the financial field. Asset transfer anonymity is one of features of the blockchain system. However, the feature of asset transfer anonymity has a great safety hazard, for example, once a user account is invaded, loss of the user cannot be traced back.

### SUMMARY OF INVENTION

The present invention provides a blockchain-based security management method, a related device and a storage medium, which can monitor blockchain accounts and guarantee fund security.

In a first aspect, the present invention provides a blockchain-based security management method, applied to a security management platform. The method comprises:

acquiring state information of a first blockchain account, wherein the state information comprises at least one of a login location and a transaction situation, and the first blockchain account is any one of blockchain accounts registered on the security management platform;

judging whether the first blockchain account is abnormal or not according to the state information; and

monitoring a fund flow direction of the first blockchain account in a blockchain network if the first blockchain account is abnormal.

In a second aspect, the present invention provides a security management device, which comprises:

an acquisition module, used for acquiring state information of a first blockchain account, wherein the state information comprises at least one of a login location and a transaction situation, and the first blockchain account is any one of blockchain accounts registered on the security management device;

a judgment module, used for judging whether the first blockchain account is abnormal or not according to the state information; and

a monitoring module, used for monitoring a fund flow direction of the first blockchain account in a blockchain network if the judgment module judges that the first blockchain account is abnormal.

In a third aspect, the present invention provides a security management platform which comprises a processor, a communication interface and a memory, wherein the processor, the communication interface and the memory are connected to one another, the memory is used for storing a computer program that include program instructions, the processor is configured to call the program instructions to carry out the blockchain-based security management method according to the first aspect.

In a fourth aspect, the present invention provides a storage medium in which instructions are stored; and when the instructions run on a computer, the computer is enabled to carry out the blockchain-based security management method according to the first aspect.

In the present invention, the state information of the first blockchain account is acquired at first, then whether the first blockchain account is abnormal or not is judged according to the state information, and the fund flow direction of the first blockchain account in the blockchain network is monitored if it is judged that the first blockchain account is abnormal, so that the blockchain account can be monitored, and fund security can be guaranteed.

### BRIEF DESCRIPTION OF THE DRAWINGS

In order to more clearly explain technical solutions in embodiments of the present invention, accompanying drawings required to be used in the embodiments will be briefly introduced below. Obviously, the accompanying drawings in the following description are only some embodiments of the present invention, and for those of ordinary skill in the art, without paying creative labor, other accompanying drawings can be obtained based on these accompanying drawings.

FIG. 1 is a schematic diagram of architecture of a security management system provided by an embodiment of the present invention;

FIG. 2 is a flowchart of a blockchain-based security management method provided by an embodiment of the present invention;

FIG. 3 is a schematic diagram of a structure of a security management device provided by an embodiment of the present invention; and

FIG. 4 is a schematic diagram of a structure of a security management platform provided by an embodiment of the present invention.

### DETAILED DESCRIPTION OF ILLUSTRATED EMBODIMENTS

The technical solutions in embodiments of the present invention will be clearly and completely described in combination with the drawings of the embodiments of the present invention.

The embodiments of the present invention provide a blockchain-based security management method, a related device and a storage medium, for monitoring the fund flow direction of a blockchain account in a blockchain network when it is judged that the blockchain account is abnormal, and thus providing a basis for subsequently tracing back funds of the blockchain account, and improving security of the funds of the blockchain account. The blockchain-based security management method provided by the embodiment of the present invention is applied to a security management platform, and will be described in detail below.

Please refer to FIG. 1, which is a schematic diagram of architecture of a security management system provided by an embodiment of the present invention, the security management system provided by the embodiment of the present invention comprises a client 10, a security management platform 20 and a blockchain network 30; and the blockchain network 30 includes a plurality of nodes 40. The client 10 and the security management platform 20 are connected via a network (such as the Internet). The security management platform 20 can access the blockchain network 30 via Ethereum, or can access the blockchain network 30 via Hyperledger, which is not limited in the embodiment of the present invention, wherein the client 10 is used for logging in a blockchain account; the security management platform 20 is used for monitoring a fund flow direction of the blockchain account registered on the security management platform 20; and funds in the blockchain account can be transferred in the blockchain network 30. In an implementation mode, the client 10 can be smart phones (such as an Android phone, an iOS phone and a Windows Phone), tablet computers, mobile Internet devices (MID), computers and other terminals that can build communication connection with the security management platform 20.

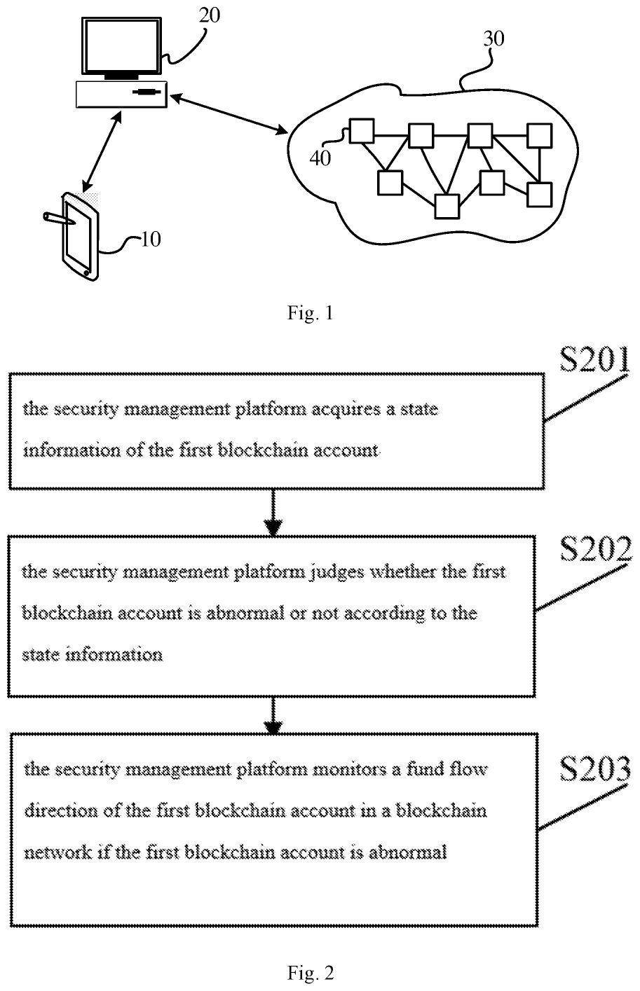

Please refer to FIG. 2 which is a flowchart of a blockchain-based security management method provided by an embodiment of the present invention. The blockchain-based security management method described in the embodiment of the present invention is applied to the security management platform 20 as shown in FIG. 1, and comprises the following steps:

S201, the security management platform acquires state information of the first blockchain account.

In the embodiment of the present invention, the first blockchain account is any one of blockchain accounts registered on the security management platform. The state information comprises a login location and/or transaction situation of the first blockchain account. The login location comprises a network identifier and/or geographic location when the first blockchain account is logged in, and the transaction situation comprises a transaction number and/or transaction amount of fund transactions between the first blockchain account and other accounts. The transaction number can be the total number of the transactions of the first blockchain account within a preset duration; and the transaction amount can comprise the transaction amount of each fund transaction of the first blockchain account within the preset duration, and can also comprise the total transaction amount of the first blockchain account within the preset duration, wherein the preset duration can be, for example, 1 hour.

In an implementation mode, the network identifier can comprise one or more of an Internet protocol (IP) address, a media access control (MAC) address, a port number of a user datagram protocol (UDP), and a port number of a transmission control protocol (TCP).

In an implementation mode, the geographic location can be a longitude and latitude in a geographic coordinate system, or can be an administrative region location that comprises a first-level administrative region location, a second-level administrative region location and a third-level administrative region location. The security management platform can acquire the geographic location of the first blockchain account in various modes, for example, after monitoring that the first blockchain account is logged in, the security management platform acquires the IP address of the client logging in the first blockchain account, acquires the geographic location of the IP address from an IP geographic location database, and takes the geographic location of the IP address as the geographic location when the first blockchain account is logged in. In addition, the security management platform can also acquire the geographic location of the client through global positioning system (GPS) equipment in the client, and takes the geographic location of the client as the geographic location when the first blockchain account is logged in.

S202, the security management platform judges whether the first blockchain account is abnormal or not according to the state information.

In the embodiment of the present invention, the state information comprises a current login location of the first blockchain account. The security management platform judges whether the current login location is matched with a common login location of the first blockchain account, and if the current login location is not matched with the common login location, the security management platform determines that the first blockchain account is abnormal, wherein the current login location comprises a current network identifier and/or current geographic location of the first blockchain account; and the common login location comprises a common network identifier and/or common geographic location when the first blockchain account is logged in. One or more common network identifiers exist, and one or more common geographic locations exist. When a network identifier is an IP address, the common network identifiers can be a range of the network identifier.

In an implementation mode, the security management platform detects whether the distance between the current geographic location of the first blockchain account and the common geographic location is within a preset distance range or not; and if the distance between the current geographic location and the common geographic location is outside the preset distance range, the security management platform determines that the current geographic location is not matched with the common geographic location, and determines that the first blockchain account is abnormal. It should be noted that if the first blockchain account has multiple common geographic locations, the security management platform firstly determines a target common geographic location from the common geographic locations, and compares the target common geographic location with the current geographic location. The target common geographic location is the one, closest to the current geographic location, of the common geographic locations.

In an implementation mode, the security management platform detects whether the network identifier identical to the current network identifier exists in the common network identifiers of the first blockchain account, and if the network identifier identical to the current network identifier does not exist in the common network identifiers, the security management platform determines that the current network identifier is not matched with the common network identifiers, and determines that the first blockchain account is abnormal.

In an implementation mode, the common geographic locations of the first blockchain account can be set by a user in the process of registering the first blockchain account, and can also be set by the user after registration of the first blockchain account is completed. The common geographic locations of the first blockchain account can also be determined by the security management platform, the security management platform acquires the login geographic locations corresponding to the first blockchain account within a preset time period, carries out statistics on the acquired login geographic locations, and determines the common geographic locations corresponding to the first blockchain account according to a statistical result. The common network identifiers of the first blockchain account can also be determined by the security management platform, the security management platform acquires the network identifiers when the first blockchain account is logged in within a preset time period, carries out statistics on the acquired network identifiers within the preset time period, and determines the common network identifiers corresponding to the first blockchain account according to a statistical result, wherein the preset time period can be six months.

In the embodiment of the present invention, the state information comprises the transaction situation of the first blockchain account. The security management platform judges whether the transaction situation meets a transaction limiting condition of the first blockchain account or not, and if the transaction situation meets the transaction limiting condition of the first blockchain account, it is determined that the first blockchain account is abnormal. The transaction limiting condition of the first blockchain account can be set by the user in the process of registering the first blockchain account, can also be set by the user after registration of the first blockchain account is completed, and can also be determined by the security management platform according to usual transaction records of the first blockchain account.

In an implementation mode, the transaction situation comprises the transaction number and/or the transaction amount. When detecting that the transaction number of the first blockchain account within a preset duration exceeds a transaction number threshold, or detecting that the transaction amount of the first blockchain account exceeds a transaction amount threshold, the security management platform determines that the transaction situation of the first blockchain account meets the transaction limiting condition, and determines that the first blockchain account is abnormal, wherein the condition that the transaction amount of the first blockchain account exceeds the transaction amount threshold can refer to that the transaction amount of the first blockchain account in one transaction exceeds a first transaction amount threshold, or the total transaction amount of the first blockchain account within the preset duration exceeds a second transaction amount threshold.

S203, the security management platform monitors a fund flow direction of the first blockchain account in a blockchain network if the first blockchain account is abnormal.

In the embodiment of the present invention, when detecting that the first blockchain account is abnormal, the security management platform sends early warning information that the first blockchain account is abnormal to the user in a communication mode bound with the first blockchain account. When detecting confirmation operation input by the user for the early warning information, the security management platform monitors the fund flow direction of the first blockchain account in the blockchain network, wherein the communication mode bound with the first blockchain account can be an instant messaging mode, and the communication mode includes a corresponding communication identifier, such as a phone number and a mailbox address. In an implementation mode, the security management platform can automatically monitor the fund flow direction of the first blockchain account in the blockchain network when detecting that the first blockchain account is abnormal. By adopting the above-mentioned mode, the fund flow direction of the first blockchain account in the blockchain network can be monitored when the condition that the first blockchain account is abnormal is detected, and thus the basis is provided for subsequently tracing back the funds of the first blockchain account.

Further, the security management platform judges whether the fund flow direction of the first blockchain account in the blockchain network is fund transfer between the first blockchain account and a second blockchain account registered on the security management platform or not, wherein the second blockchain account is any one of the blockchain accounts registered on the security management platform except the first blockchain account. If the security management platform judges that the fund flow direction is the fund transfer between the first blockchain account and the second blockchain account registered on the security management platform, the security management platform acquires a target blockchain account, to which the funds are transferred, in the second blockchain account. It should be noted that the target blockchain account can be one or more blockchain accounts, and the target blockchain account can comprise the blockchain account to which the funds in the first blockchain account are finally transferred, and can also comprise the blockchain account through which the funds in the first blockchain account flow during a transfer process. By adopting the above-mentioned mode, the fund flow direction of the first blockchain account in the blockchain network can be accurately positioned when the condition that the first blockchain account is abnormal is detected, and thus the funds of the first blockchain account can be subsequently traced back.

In an implementation mode, before acquiring the state information of the first blockchain account, the security management platform receives a registration request about the first blockchain account sent by the user via the client, and the registration request carries user information, information of the common login location and the transaction limiting condition; and the security management platform verifies the user information carried by the registration request, registers the first blockchain account when the user information is successfully verified, and stores the transaction limiting condition and the information of the common login location of the first blockchain account.

In an implementation mode, the user information carried by the registration request comprises identity document information of the user, wherein the identity document information can include the gender, name, identification card number, identification card photo, residential address and other information of the user. The security management platform acquires identity verification information of the user from a target database according to the identity document information. The target database can be a database of a household registration department or a public security department, wherein the identity verification information comprises the document information of the user, and the document information can comprise one or more of the gender, name, identification card number, identification card photo and residential address of the user. Furthermore, the security management platform verifies the identity document information carried by the registration request according to the document information included in the identity verification information. When the document information included in the identity verification information is consistent with all information in the identity document information carried by the registration request, the security management platform determines that the user information carried by the registration request is successfully verified.

In an implementation mode, when detecting that the first blockchain account is abnormal, the security management platform sends a prompt message to the user in the communication mode bound with the first blockchain account, and the prompt message is used for prompting the user whether to freeze the first blockchain account or not; and when detecting the confirmation operation input by the user for the prompt message, the security management platform freezes the first blockchain account. After the first blockchain account is frozen, the security management platform refuses to transfer the funds in the first blockchain account. Further, the security management platform generates a freezing request about the first blockchain account, and the freezing request is used for requesting the blockchain network to freeze the first blockchain account; and the security management platform sends the freezing request to nodes in the blockchain network, so that the nodes in the blockchain network refuse fund transfer about the first blockchain account after receiving the freezing request. By adopting the above-mentioned mode, the blockchain account can be frozen when the condition that the blockchain account is abnormal is detected, so that the funds in the blockchain account are prevented from being transferred again, and loss of the user is reduced.

In the embodiment of the present invention, the security management platform firstly acquires the state information of the first blockchain account, then judges whether the first blockchain account is abnormal or not according to the state information, and monitors the fund flow direction of the first blockchain account in the blockchain network if it is judged that the first blockchain account is abnormal, so that the blockchain account can be monitored, and fund security can be guaranteed.

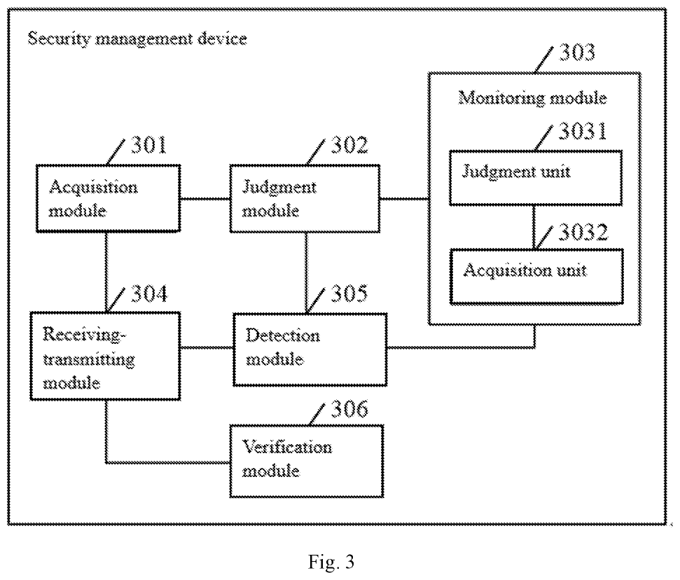

Please refer to FIG. 3 which is a schematic diagram of a structure of a security management device provided by an embodiment of the present invention. The security management device described in the embodiment of the present invention comprises:

an acquisition module 301, used for acquiring state information of a first blockchain account, wherein the state information comprises at least one of a login location and a transaction situation, and the first blockchain account is any one of blockchain accounts registered on the security management device;

a judgment module 302, used for judging whether the first blockchain account is abnormal or not according to the state information; and

a monitoring module 303, used for monitoring a fund flow direction of the first blockchain account in a blockchain network if the judgment module 302 judges that the first blockchain account is abnormal.

In an implementation mode, under the condition that the state information comprises the login location, the operation of judging whether the first blockchain account is abnormal or not according to the state information by the judgment module 302 specifically comprises:

judging whether the login location is matched with a common login location of the first blockchain account, wherein the login location comprises at least one of a network identifier and a geographic location; and

determining that the first blockchain account is abnormal if the login location is not matched with the common login location.

In an implementation mode, under the condition that the state information comprises the transaction situation, the operation of judging whether the first blockchain account is abnormal or not according to the state information by the judgment module 302 specifically comprises:

judging whether the transaction situation meets a transaction limiting condition of the first blockchain account or not, wherein the transaction situation comprises at least one of a transaction number and a transaction amount; and

determining that the first blockchain account is abnormal if the transaction situation meets the transaction limiting condition.

In an implementation mode, the security management device also comprises:

a receiving-transmitting module 304, used for sending early warning information that the first blockchain account is abnormal to a user; and

a detection module 305, used for triggering the monitoring module 303 to monitor the fund flow direction of the first blockchain account in the blockchain network when confirmation operation input by the user for the early warning information is detected.

In an implementation mode, the monitoring module 303 specifically comprises:

a judgment unit 3031, used for judging whether the fund flow direction of the first blockchain account in the blockchain network is fund transfer between the first blockchain account and a second blockchain account registered on the security management device or not, and

an acquisition unit 3032, used for acquiring a target blockchain account, to which the funds are transferred, in the second blockchain account if the judgment unit 3031 judges that the fund flow direction of the first blockchain account in the blockchain network is the fund transfer between the first blockchain account and the second blockchain account registered on the security management device,

wherein the second blockchain account is any one of the blockchain accounts registered on the security management device except the first blockchain account.

In an implementation mode, the receiving-transmitting module 304 is also used for receiving a registration request about the first blockchain account, wherein the registration request carries user information, information of the common login location and the transaction limiting condition;

wherein, the security management device also comprises:

a verification module 306, used for verifying the user information, and registering the first blockchain account when the user information is successfully verified.

In an implementation mode, the security management device accesses the blockchain network via Ethereum or Hyperledger.

It is understandable that functions of various functional modules and units of the security management device provided by the embodiment of the present invention can be embodied in accordance with the method provided by the above-mentioned method embodiments, and the specific implementation of the functions can be with reference to associated description of the above-mentioned method embodiments and will not be described in detail herein.

In the embodiment of the present invention, the acquisition module 301 firstly acquires the state information of the first blockchain account, then triggers the judgment module 302 to judge whether the first blockchain account is abnormal or not according to the state information, and triggers the monitoring module 303 to monitor the fund flow direction of the first blockchain account in the blockchain network if it is judged that the first blockchain account is abnormal, so that the blockchain account can be monitored, and fund security can be guaranteed.

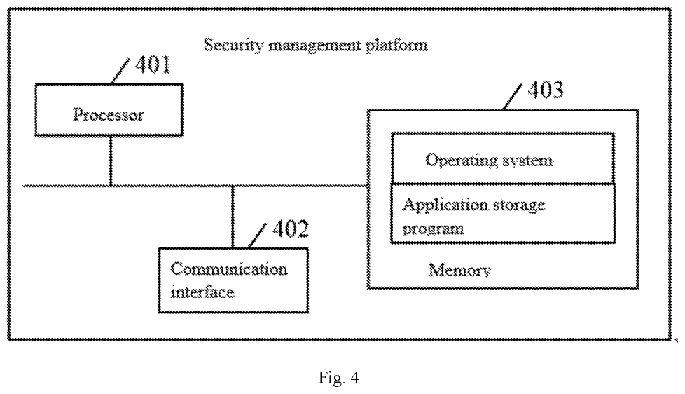

Please refer to FIG. 4 which is a schematic diagram of a structure of a security management platform provided by an embodiment of the present invention; the security management platform described in the embodiment of the present invention is applied to the blockchain, and comprises a processor 401, a communication interface 402 and a memory 403, wherein the processor 401, the communication interface 402 and the memory 403 can be connected through a bus or other modes, and the embodiment of the present invention takes the connection through the bus as an example.

The processor 401 can be a central processing unit (CPU), a network processor (NP), a graphics processing unit (GPU), or a combination of the CPU, GPU, and NP. The processor 401 can also be a core of a multi-core CPU, a multi-core GPU, or a multi-core NP to implement binding of the communication identifiers.

The processor 401 can be a hardware chip. The hardware chip can be an application-specific integrated circuit (ASIC), a programmable logic device (PLD), or a combination thereof. The PLD can be a complex programmable logic device (CPLD), a field-programmable gate array (FPGA), generic array logic (GAL), or any combination thereof.

The communication interface 402, which can be a transceiver, can be used for receiving and transmitting information or interacting signaling, and receiving and delivering signals.

The memory 403 can mainly comprise a program storage area and a data storage area, wherein the program storage area can store an operating system and a storage program (such as a text storage function and a location storage function) required by at least one function; and the data storage area can store data (such as image data and text data) and the like created from the use of the security management platform, and can include application storage programs and the like. In addition, the memory 403 can comprise a high-speed random access memory, and can also comprise a non-volatile memory, such as at least one magnetic disk storage device, a flash memory device, or other volatile solid-state storage devices.

The memory 403 is also used for storing program instructions. The processor 401 can call the program instructions stored in the memory 403 to implement the blockchain-based security management method as shown in the embodiment of the present invention.

Specifically, the processor 401 calls the program instructions stored in the memory 403 to execute the following steps:

acquiring state information of a first blockchain account, wherein the state information comprises at least one of a login location and a transaction situation, and the first blockchain account is any one of blockchain accounts registered on the security management platform;

judging whether the first blockchain account is abnormal or not according to the state information; and

monitoring a fund flow direction of the first blockchain account in a blockchain network if the first blockchain account is abnormal.

In an implementation mode, under the condition that the state information comprises the login location, the operation of judging whether the first blockchain account is abnormal or not according to the state information by the processor 401 specifically comprises:

judging whether the login location is matched with a common login location of the first blockchain account, wherein the login location comprises at least one of a network identifier and a geographic location; and

determining that the first blockchain account is abnormal if the login location is not matched with the common login location.

In an implementation mode, under the condition that the state information comprises the transaction situation, the operation of judging whether the first blockchain account is abnormal or not according to the state information by the processor 401 specifically comprises:

judging whether the transaction situation meets a transaction limiting condition of the first blockchain account or not, wherein the transaction situation comprises at least one of a transaction number and a transaction amount; and

determining that the first blockchain account is abnormal if the transaction situation meets the transaction limiting condition.

In an implementation mode, the operation of monitoring the fund flow direction of the first blockchain account in the blockchain network by the processor 401 specifically comprises:

sending early warning information that the first blockchain account is abnormal to a user via the communication interface 402; and

monitoring the fund flow direction of the first blockchain account in the blockchain network when confirmation operation input by the user for the early warning information is detected.

In an implementation mode, the operation of monitoring the fund flow direction of the first blockchain account in the blockchain network by the processor 401 specifically comprises:

judging whether the fund flow direction of the first blockchain account in the blockchain network is fund transfer between the first blockchain account and a second blockchain account registered on the security management platform or not; and

if yes, acquiring a target blockchain account, to which funds are transferred, in the second blockchain account;

wherein the second blockchain account is any one of the blockchain accounts registered on the security management platform except the first blockchain account.

In an implementation mode, before the processor 401 acquires the state information of the first blockchain account, the processor 401 is also used for

receiving a registration request about the first blockchain account via the communication interface 402, wherein the registration request carries user information, information of the common login location and the transaction limiting condition; and

verifying the user information, and registering the first blockchain account when the user information is successfully verified.

In specific implementations, the processor 401, the communication interface 402 and the memory 403 described in the embodiment of the present invention can execute the implementation mode of the security management platform described in the blockchain-based security management method provided by the embodiment of the present invention, which will not be described in detail herein.

In the embodiment of the present invention, the processor 401 firstly acquires the state information of the first blockchain account, then judges whether the first blockchain account is abnormal or not according to the state information, and monitors the fund flow direction of the first blockchain account in the blockchain network if it is judged that the first blockchain account is abnormal, so that the blockchain account can be monitored, and fund security can be guaranteed.

An embodiment of the present invention also provides a computer readable storage medium in which security management instructions are stored; and when the instructions run on a computer, the computer is enabled to carry out the blockchain-based security management method according to the above-mentioned method embodiments.

It should be noted that the various above-mentioned method embodiments are, for simplicity of description, all expressed as combinations of a series of actions, but those skilled in the art should be appreciated that the present invention is not limited by the order of the actions described, as some steps can be carried out in other orders or concurrently in accordance with the present invention. Secondly, those skilled in the art should also be appreciated that the embodiments described in the specification are all preferred embodiments and that the actions and modules involved are not necessarily essential to the present invention.

The steps in the method provided by the embodiment of the present invention can be sequentially adjusted, combined and deleted according to actual needs. The functional modules or units in the device provided by the embodiment of the present invention can be combined, divided and deleted according to actual needs.

Those of ordinary skill in the art can understand that all or part of the steps of various methods provided by the above-mentioned embodiments can be accomplished by instructing related hardware through the programs; and the programs can be stored in the computer readable storage medium, and the storage medium can be a flash disk, a read-only memory (ROM), a random access memory (RAM), a magnetic or optical disk, or the like.

The foregoing disclosure has been only a kind of preferred embodiments of the present invention and, of course, is not intended to limit the scope of the present invention, and those of ordinary skill in the art should appreciate that all or part of the procedures for implementing the above-mentioned embodiments, and equivalent changes made in accordance with the claims of the present invention remain within the scope of the present invention.

1. A blockchain-based security management method, applied to a security management platform, characterized by comprising:
acquiring a state information of a first blockchain account, wherein the state information comprises at least one of a login location and a transaction situation, and the first blockchain account is any one of blockchain accounts registered on the security management platform;
judging whether the first blockchain account is abnormal or not according to the state information; and
monitoring a fund flow direction of the first blockchain account in a blockchain network if the first blockchain account is abnormal.

2. The method according to claim 1, characterized in that the state information comprises the login location, and the operation of judging whether the first blockchain account is abnormal or not according to the state information comprises:
judging whether the login location is matched with a common login location of the first blockchain account or not, wherein the login location comprises at least one of a network identifier and a geographic location; and
determining that the first blockchain account is abnormal if the login location is not matched with the common login location.

3. The method according to claim 1, characterized in that the state information comprises the transaction situation, the operation of judging whether the first blockchain account is abnormal or not according to the state information comprises:
judging whether the transaction situation meets a transaction limiting condition of the first blockchain account or not, wherein the transaction situation comprises at least one of a transaction number and a transaction amount; and
determining that the first blockchain account is abnormal if the transaction situation meets the transaction limiting condition.

4. The method according to claim 1, characterized in that the operation of monitoring the fund flow direction of the first blockchain account in the blockchain network comprises:
sending an early warning information that the first blockchain account is abnormal to a user; and
monitoring the fund flow direction of the first blockchain account in the blockchain network when a confirmation operation input by the user for the early warning information is detected.

5. The method according to claim 1, characterized in that the operation of monitoring the fund flow direction of the first blockchain account in the blockchain network comprises:
judging whether the fund flow direction of the first blockchain account in the blockchain network is a fund transfer between the first blockchain account and a second blockchain account registered on the security management platform or not, and
acquiring a target blockchain account, to which the fund is transferred, in the second blockchain account if a result is yes,
wherein the second blockchain account is any one of the blockchain accounts registered on the security management platform except the first blockchain account.

6. The method according to claim 1, characterized in that before acquiring the state information of the first blockchain account, the method also comprises:
receiving a registration request about the first blockchain account, wherein the registration request carries a user information, a common login location information and a transaction limiting condition; and
verifying the user information, and registering the first blockchain account when the user information is successfully verified.

7. The method according to claim 1, characterized in that the security management platform accesses the blockchain network via Ethereum or Hyperledger.

8. A security management device, characterized by comprising:
an acquisition module, used for acquiring a state information of a first blockchain account, wherein the state information comprises at least one of a login location and a transaction situation, and the first blockchain account is any one of blockchain accounts registered on the security management device;
a judgment module, used for judging whether the first blockchain account is abnormal or not according to the state information; and
a monitoring module, used for monitoring a fund flow direction of the first blockchain account in a blockchain network if the judgment module judges that the first blockchain account is abnormal.

9. (canceled)

10. A storage medium in which instructions are stored, characterized in that when the instructions run on a computer, the computer is enabled to carry out the blockchain-based security management method according to claim 1.

11. The method according to claim 2, characterized in that the operation of monitoring the fund flow direction of the first blockchain account in the blockchain network comprises:
sending an early warning information that the first blockchain account is abnormal to a user; and
monitoring the fund flow direction of the first blockchain account in the blockchain network when a confirmation operation input by the user for the early warning information is detected.

12. The method according to claim 3, characterized in that the operation of monitoring the fund flow direction of the first blockchain account in the blockchain network comprises:
sending an early warning information that the first blockchain account is abnormal to a user; and
monitoring the fund flow direction of the first blockchain account in the blockchain network when a confirmation operation input by the user for the early warning information is detected.

13. The method according to claim 2, characterized in that the operation of monitoring the fund flow direction of the first blockchain account in the blockchain network comprises:
judging whether the fund flow direction of the first blockchain account in the blockchain network is a fund transfer between the first blockchain account and a second blockchain account registered on the security management platform or not, and
acquiring a target blockchain account, to which the fund is transferred, in the second blockchain account if a result is yes,
wherein the second blockchain account is any one of the blockchain accounts registered on the security management platform except the first blockchain account.

14. The method according to claim 3, characterized in that the operation of monitoring the fund flow direction of the first blockchain account in the blockchain network comprises:
judging whether the fund flow direction of the first blockchain account in the blockchain network is a fund transfer between the first blockchain account and a second blockchain account registered on the security management platform or not, and
acquiring a target blockchain account, to which the fund is transferred, in the second blockchain account if a result is yes,
wherein the second blockchain account is any one of the blockchain accounts registered on the security management platform except the first blockchain account.
